(19) United States
(12) Patent Application Publication
(10) Pub. No.: US 2017/0161386 A1
(43) Pub. Date: Jun. 8, 2017

(54) ADAPTIVE PRODUCT QUESTIONNAIRE

(71) Applicant: International Business Machines Corporation, Armonk, NY (US)

(72) Inventors: Kinichi Mitsui, Tokyo (JP); Masaki Wakao, Sagamihara-Shi (JP); Takeshi Watanabe, Kawasaki (JP)

(21) Appl. No.: 14/956,677

(22) Filed: Dec. 2, 2015

(51) Int. Cl. G06F 17/30; G06Q 30/02

(52) U.S. Cl. CPC G06F 17/30867; G06Q 30/0203

(57) ABSTRACT

A system may administer a survey to a user who is test driving a vehicle. The system may identify a profile for the user. The system can detect a driving condition from external devices, for example, sensors on the vehicle. A first query of the survey, based on the driving condition, can be sent to a client device like a cell phone. The system can then receive an answer to the query, and analyze the answer as well as the driving condition. Based on the analysis, the system can then send a second query to the client device.

### BACKGROUND

The present disclosure relates to questionnaire delivery, and more specifically, to interactive questionnaire delivery during vehicle test drives.

A test drive is the driving of an automobile to assess its drivability, roadworthiness, and general operating state. Test drives may be used by vehicle traders or manufactures to allow prospective customers to determine the suitability of the vehicle to their driving style. They can also be used to determine the safety and ease with which a particular vehicle navigates certain road and weather conditions. Automotive manufacturers can gather useful data about the market from their customers' test drives and feedback.

### SUMMARY

Embodiments of the present disclosure may be directed toward a method for administering a survey to a user test driving a vehicle. A system may identify a user profile, where the user profile is associated with the user. A driving condition may then be detected by the system, from one or more external devices. A first query of the survey may be sent to a client device based on driving conditions, and an answer to the first query can be received from the client device. The system can then analyze the driving condition and the answer to the first query in order to determine a second query of the survey to send to the client device.

Embodiments of the present disclosure may be directed toward a system for administering a survey to a user test driving a vehicle. The system may have a computer readable storage medium with program instructions stored thereon. The system may also have one or more processors that are configured to execute the program instructions to perform steps. These steps may include first identifying a user profile, where the user profile is associated with the user. A driving condition may then be detected by the system from one or more external devices. A first query of the survey may be sent to a client device based on driving conditions, and an answer to the first query can be received from the client device. The system can then analyze the driving condition and the answer to the first query in order to determine a second query of the survey to send to the client device.

Embodiments of the present disclosure may be directed toward a computer program product for administering a survey to a user test driving a vehicle. The computer program product may have a compute readable storage medium with program instructions embodied therewith, and the computer readable storage medium is not a transitory signal per se. The program instructions may be executable by a computer processor to cause the processor to first identify a user profile. The user profile may be associated with the user. A driving condition may then be detected by the system from one or more external devices. A first query of the survey may be sent to a client device based on driving conditions, and an answer to the first query can be received from the client device. The system can then analyze the driving condition and the answer to the first query in order to determine a second query of the survey to send to the client device.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an example computing environment in which embodiments of the present disclosure may be implemented.

FIG. 2 depicts a block diagram of an example system architecture, including a natural language processing system, configured to analyze received answers, a query bank of potential questions, driving condition data, and a user profile to generate a query or set of queries to collect test drive data from a user, according to embodiments.

FIG. 3 depicts a system diagram of an example of a high level logical architecture of a Question Answering (QA) system configured to use a profile, answer, and driving conditions to generate queries for a test drive survey, according to embodiments.

FIG. 4 depicts a flow diagram of a method for developing and sending a driving survey to a user, based on driving conditions and driving situations, according to embodiments.

FIG. 5 depicts a system diagram of an incentives offer solution for a user test driving a vehicle, according to embodiments.

FIG. 6 depicts a flow diagram of a method for generating a question for a test drive, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to questionnaire delivery, and more particular aspects relate to interactive questionnaire delivery during vehicle test drives. While the present disclosure is not necessarily limited to such applications, various aspects of the disclosure may be appreciated through a discussion of various examples using this context.

Automotive manufactures and other companies may wish to gather market data from customers when the customers test drive vehicles. This market data may be used for product promotion and requirement validation for example, to validate certain safety or performance requirements. According to embodiments, a system may capture personalized market data about a test drive, based on a type of customer and the customer's driving experience. The system may identify a user profile. The user profile may have been created based on data entered into a client device including, for example, a smartphone, tablet, a laptop, a personal computer, or an entry device that is part of an intelligent vehicle system. In some embodiments, the data in the profile may have been entered at an earlier time, and accessed upon the syncing of a particular device to the system or upon entry of account or login credentials to a device (e.g., one of the devices described above).

In embodiments, the system may monitor for driving conditions based on data received from, for example, sensors installed in the vehicle. The system may then detect a driving condition from an external device or devices. For example, driving condition and environment data may be captured by a smart phone using internet services to access weather data, sensors installed within the vehicle to capture temperature data, and a camera installed within the vehicle to capture other driving and environment-related data. For example, the system may detect that the vehicle is on an icy terrain, or it may detect that the weather is below freezing. Based on the driving condition, the system can send a first query. In some embodiments, prior to the detection of driving conditions and the first query, the system may send a set of one or more queries that have been selected for a user based on user-entered data. These queries may be completed by the user prior to the start of the test drive. In some embodiments, the first query can be determined using natural language processing (NLP) of the data in the user profile as well as driving conditions. In some cases, a set of one or more previous answers to survey questions may be available for use in NLP analysis, for example, the questions sent prior to the test drive, as mentioned above. In other cases, a database of candidate queries may be searched and used in NLP processing in determining the first query. In other cases, a subset of the candidate queries may be used, where the subset is determined based on a user profile characteristic or a user group, including, for example, a geographic location.

The first query may be a question for the driver or a passenger to answer. It may be about the driving condition itself, operation of the vehicle in the driving condition, or another relevant question. In some embodiments, a set of one or more queries may be sent to the driver (e.g., via a download to a smartphone or vehicle device) prior to the start of the environment-based, interactive query set. The system may then wait to receive an answer to the first query. In embodiments, the answer may come from a device as described above (e.g., a client device such as a smartphone or device that is part of an intelligent vehicle system). The driver or other user to whom the survey is directed may provide an audio (spoken) response or may enter a response into a keypad (e.g., if user is not currently driving). In some embodiments, an answer may be submitted to the system automatically (e.g., without direct entry from the user), for example, in response to a user satisfying a driving-condition-related question.

In response to receiving an answer, the system may analyze the driving condition and the answer to the first query to a server for analysis. In some cases, an answer may be received in an audio format (e.g., if a user speaks into a smartphone or in-vehicle device), and may be converted by the system into a text format, for further analysis or processing. In embodiments, NLP may be used to analyze the driving condition and the answer. In some embodiments, the weather data and answer may be uploaded to a server for analysis. Based on the analysis, the system can then send to the client device a second query of the survey. A survey can then be created and delivered to a user in real-time, based on changing driving conditions, an automotive manufacturer's needs, and repeated feedback and responses from a user.

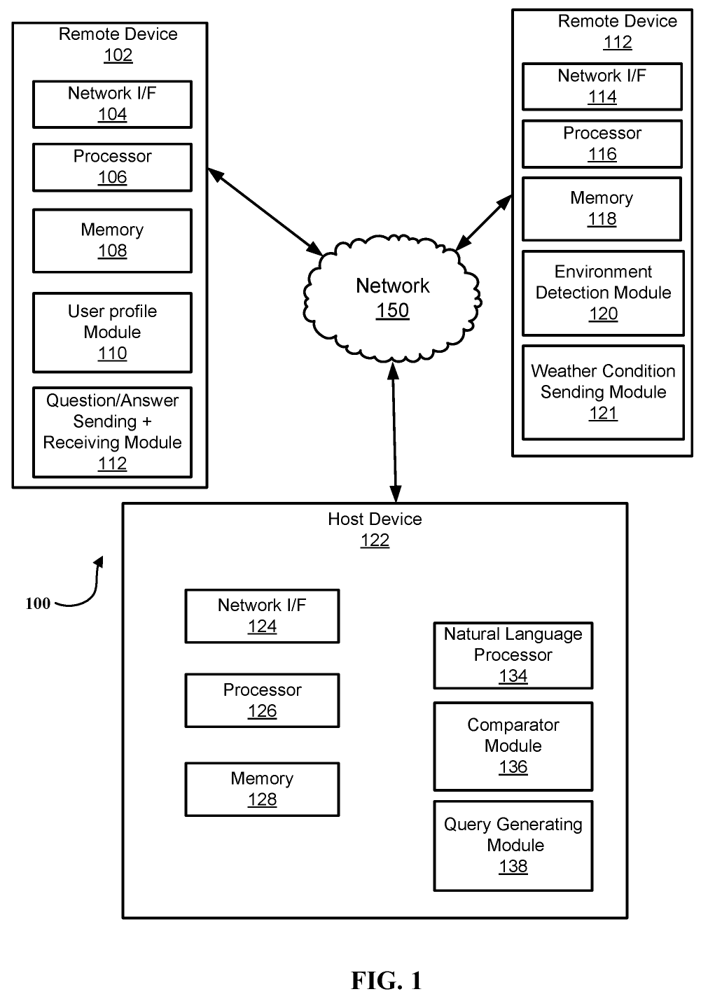

FIG. 1 depicts a block diagram of an example computing environment 100 in which embodiments of the present disclosure may be implemented. In some embodiments, the computing environment 100 may include two remote devices 102 and 112 and a host device 122.

Consistent with various embodiments, the host device 122 and the remote devices 102 and 112 may be computer systems. The remote devices 102 and 112 and the host device 122 may include one or more processors 106, 116, and 126 and one or more memories 108, 118, and 128, respectively. The remote devices 102 and 112 and the host device 122 may be configured to communicate with each other through an internal or external network interface 104, 114, and 124. The network interfaces 104, 114, and 124 may be, for example, modems or network interface cards. The remote devices 102 and 112 and/or the host device 122 may be equipped with a display or monitor. Additionally, the remote devices 102 and 112 and/or the host device 122 may include optional input devices (e.g., a keyboard, mouse, scanner, or other input device), and/or any commercially available or custom software (e.g., browser software, communications software, server software, natural language processing software, search engine and/or web crawling software, filter modules for filtering content based upon predefined parameters, etc.). In some embodiments, the remote devices 102 and 112 and/or the host device 122 may be servers, desktops, laptops, or hand-held devices. In embodiments, remote device 112 may be installed in a vehicle, and may communicate with, and receive data from, one or more sensors or other device installed within the vehicle. In some embodiments, remote device 112 may be a part of an intelligent vehicle system.

The remote devices 102 and 112 and the host device 122 may be distant from each other and communicate over a network 150. In some embodiments, the network 150 can be implemented using any number of any suitable communications media. For example, the network 150 may be a wide area network (WAN), a local area network (LAN), the Internet, or an intranet. In certain embodiments, the remote devices 102 and 112 and the host device 122 may be local to each other, and communicate via any appropriate local communication medium. For example, the remote devices 102 and 112 and the host device 122 may communicate using a local area network (LAN), one or more hardwire connections, a wireless link or router, or an intranet. In some embodiments, the remote devices 102 and 112 and the host device 122 may be communicatively coupled using a combination of one or more networks and/or one or more local connections.

In some embodiments, the network 150 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 150.

In some embodiments, the remote device 102 may enable users to receive questions from and submit answers to host device 122. The questions can be formatted in a variety of ways including text, image, audio, and video. For example, the remote device 102 may include a question/answer sending and receiving module 112 and a user interface (UI). The question/answer sending and receiving module 112 may be in the form of a web browser or any other suitable software module, and the UI may be any type of interface (e.g., command line prompts, menu screens, graphical user interfaces). The UI may allow a user to interact with the remote device 102 to send and receive questions and answers to and from the host device 122.

In embodiments, remote device 102 may also include a user profile module 110. User profile module 110 may access, from one or more external or internal data sources, a user profile for a particular user and present it to the host device 122. In some embodiments, the user profile may be stored remotely, for example, on a server (not pictured), on host device 122, or in another location. In embodiments, the user profile may be created based off of responses received to a set of questions presented to a user prior to the test drive. The user profile may contain individualized data about the user, including age, driving experience, geographic location, vehicle type desired, driving record, driving experience, and other data relevant to the automotive manufacturer's segmentation of market data.

In some embodiments, the remote device 112 may be installed in a vehicle that is being test driven, and it may be a part of an intelligent vehicle system. Remote device may include an environment detection module 120 and a weather condition sending module 121. The environment detection module 120 may receive weather condition data from one or more sensors installed on a vehicle. The environment detection module 120 may process the weather data and send the data to the weather condition sending module 121. The weather condition sending module 121 may communicate with the host device 122, and send one or more weather conditions to the host device.

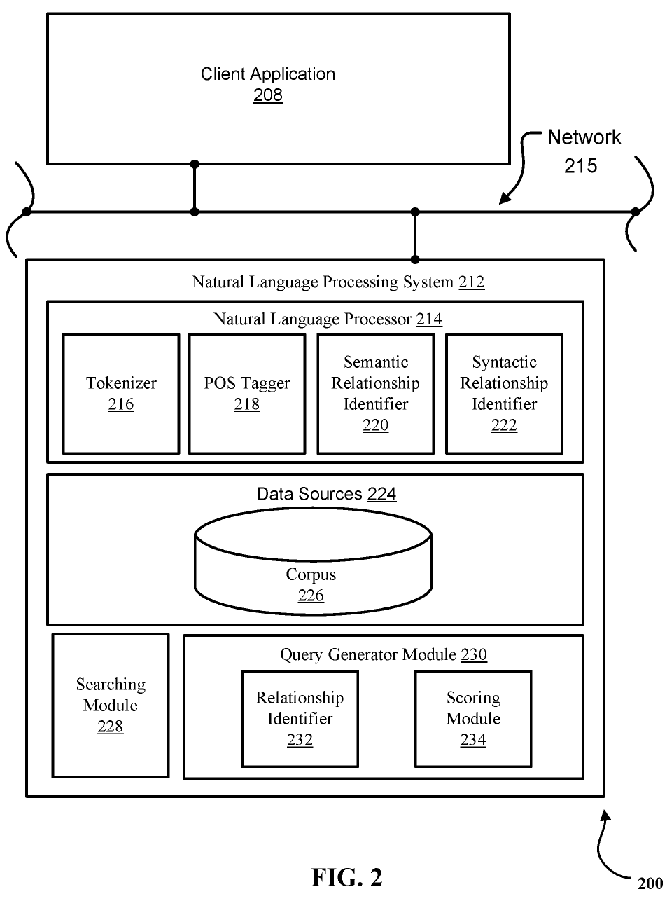

In some embodiments, the host device 122 may include a natural language processor 134, a comparator module 136, and a query generating module 138. The natural language processor 134 may include numerous subcomponents, such as a tokenizer, a part-of-speech (POS) tagger, a semantic relationship identifier, and a syntactic relationship identifier. An example natural language processor is discussed in more detail in reference to FIG. 2. The natural language processor 134 may be configured to perform natural language processing to ingest a database containing questions maintained by the automotive manufacturer or survey provider, to ingest answers or other data received in response to questions (e.g., answers submitted by remote device 102) and/or to ingest weather condition data (e.g., content submitted by remote device 112).

The comparator module 136 may be implemented using a conventional or other search engine, and may be distributed across multiple computer systems. The comparator module 136 may be configured to search one or more databases or other computer systems for content ingested by the natural language processor 134. For example, the comparator module 136 may be configured to compare ingested content about the current weather conditions outside the vehicle (and received from the weather condition sending module 121) and answers received from remote device 102 (e.g., from question/answer sending and receiving module 112), and user profile data from user profile module 110, in order to help identify questions from a question database to be generated next for the user (e.g., by query generating module 138). For example, weather conditions used by the comparator module 136 may include both current weather conditions as detected from a set of one or more sensors that may be installed on or in the vehicle. As described herein, the conditions may also be received from other sensors and devices within the vehicle, including, for example, data about the vehicle's speed, elevation, incline, and other data. Condition data may also include weather condition data received about the weather and driving conditions including data accessed using the Internet. For example, this data could include weather forecast data, driving and traffic conditions, roadway data, or other data.

The query generating module 138 may be configured to analyze a question database and to generate a question to be submitted to a user test driving a vehicle and completing a test driving survey. The query generating module 138 may include one or more modules or units, and may utilize the comparator module 136, to perform its functions (e.g., to determine a relationship between content of driving conditions, questions in the automotive manufacturer's database, and answers received from the remote device 102), as discussed in more detail in reference to FIG. 2.

While FIG. 1 illustrates a computing environment 100 with a single host device 122 and two remote devices 102 and 112, suitable computing environments for implementing embodiments of this disclosure may include any number of remote devices and host devices. The various models, modules, systems, and components illustrated in FIG. 1 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze content from an internet site (including, e.g., weather condition data, traffic data, roadway closure data, or other data relevant to driving conditions), and the second host device may include a natural language processing system configured to receive and analyze answers received from a driver.

It is noted that FIG. 1 is intended to depict the representative major components of an exemplary computing environment 100. In some embodiments, however, individual components may have greater or lesser complexity than as represented in FIG. 1, components other than or in addition to those shown in FIG. 1 may be present, and the number, type, and configuration of such components may vary.

FIG. 2 depicts a block diagram of an example system architecture 200, including a natural language processing system 212, configured to analyze received answers, a query bank of potential questions, driving condition data, and a user profile to generate a query or set of queries to collect test drive data from a user, according to embodiments. In some embodiments, a remote device (such as remote device 102 of FIG. 1) may submit answers (such as a response to a question about the vehicle's handling in a driving condition) to be analyzed to the natural language processing system 212 which may be housed on a host device (such as host device 122 of FIG. 1). In some embodiments, a second remote device (such as remote device 112 of FIG. 1) may submit driving condition data (such as content about road conditions, weather conditions, or other vehicle data) to be analyzed to the natural language processing system 212. Such remote devices may each include a client application 208, which may itself involve one or more entities operable to generate, send, or receive driving data and response data that is then dispatched to a natural language processing system 212 via a network 215.

Consistent with various embodiments, the natural language processing system 212 may respond to content submissions sent by a client application 208. Specifically, the natural language processing system 212 may analyze a user profile received from the client application 208 to identify characteristics about the user, and analyze answers received from the client application 208 to identify characteristics about the answers (e.g., a theme, main idea, and characters). In some embodiments, the natural language processing system 212 may include a natural language processor 214, data sources 224, a searching module 228, and a query generator module 230. The natural language processor 214 may be a computer module that analyzes the received content. The natural language processor 214 may perform various methods and techniques for analyzing the received content (e.g., syntactic analysis, semantic analysis, etc.). The natural language processor 214 may be configured to recognize and analyze any number of natural languages. In some embodiments, the natural language processor 214 may parse passages of the received content. Further, the natural language processor 214 may include various modules to perform analyses of electronic documents. These modules may include, but are not limited to, a tokenizer 216, a part-of-speech (POS) tagger 218, a semantic relationship identifier 220, and a syntactic relationship identifier 222.

In embodiments, the tokenizer 216 may be a computer module that performs lexical analysis. The tokenizer 216 may convert a sequence of characters into a sequence of tokens. A token may be a string of characters included in written passage and categorized as a meaningful symbol. Further, in some embodiments, the tokenizer 216 may identify word boundaries in content and break any text passages within the content into their component text elements, such as words, multiword tokens, numbers, and punctuation marks. In some embodiments, the tokenizer 216 may receive a string of characters, identify the lexemes in the string, and categorize them into tokens.

Consistent with embodiments, the POS tagger 218 may be a computer module that marks up a word in passages to correspond to a particular part of speech. The POS tagger 218 may read a passage or other text in natural language and assign a part of speech to each word or other token. The POS tagger 218 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more segments of previously analyzed content (e.g., the content of received driving condition may shed light on a user answer, or a previously sent query may help inform the answer of a later question). Examples of parts of speech that may be assigned to words include, but are not limited to, nouns, verbs, adjectives, adverbs, and the like. Examples of other part of speech categories that POS tagger 218 may assign include, but are not limited to, comparative or superlative adverbs, wh-adverbs, conjunctions, determiners, negative particles, possessive markers, prepositions, wh-pronouns, and the like. In some embodiments, the POS tagger 218 may tag or otherwise annotate tokens of a passage with part of speech categories. In some embodiments, the POS tagger 218 may tag tokens or words of a passage to be parsed by the natural language processing system 212.

In embodiments, the semantic relationship identifier 220 may be a computer module that may be configured to identify semantic relationships of recognized text elements (e.g., words, phrases) in received content. In some embodiments, the semantic relationship identifier 220 may determine functional dependencies between entities and other semantic relationships.

Consistent with embodiments, the syntactic relationship identifier 222 may be a computer module that may be configured to identify syntactic relationships in a passage composed of tokens. The syntactic relationship identifier 222 may determine the grammatical structure of sentences such as, for example, which groups of words are associated as phrases and which word is the subject or object of a verb. The syntactic relationship identifier 222 may conform to formal grammar.

In embodiments, the natural language processor 214 may be a computer module that may parse received content and generate corresponding data structures for one or more portions of the received content. For example, in response to receiving an answer from the client application 208 at the natural language processing system 212, the natural language processor 214 may output parsed text elements of the answer as data structures. In some embodiments, a parsed text element may be represented in the form of a parse tree or other graph structure. To generate the parsed text element, the natural language processor 214 may trigger computer modules 216-222.

In embodiments, the output of natural language processor 214 (e.g., ingested content) may be stored within data sources 224, such as corpus 226. As used herein, a corpus may refer to one or more data sources, such as the data sources 224 of FIG. 2. In some embodiments, the data sources 224 may include data warehouses, corpora, data models, and document repositories. In some embodiments, the corpus 226 may be a relational database. In embodiments, the corpus 226 may comprise data from one or more submitted query data repositories, which may be submitted from one or more query developers or automotive manufacturers.

In some embodiments, the query generator module 230 may be a computer module that compares ingested content of answers to ingested content of a user profile, driving condition data, and historical question and answer data. In some embodiments, the query generator module 230 may include a relationship identifier 232 and scoring module 234. The scoring module 234 may evaluate and analyze a relationship between the ingested content of the answers, the ingested content of a driving condition, and the queries in a query data repository. This may be done by searching the answers for semantic similarities and conceptual overlaps with ingested content of the query database and driving condition data. Certain similarities between the two sets of ingested content may be weighted more heavily than others.

In some embodiments, the relationship identifier 232 first identifies a main idea within the ingested content, and then the relationship identifier 232 may search the ingested content of the query repository for substantially similar content. Such similar content may include words or phrases indicating date, characters, or words that are related to content within the answers or driving conditions. In some embodiments, in order to identify query-database content associated with one or more main ideas of the answer or driving-condition content, the relationship identifier 232 may search the corpus 226 for related concepts.

In embodiments, after relationship identifier 232 identifies a relationship between the ingested answer, driving conditions, and the ingested content of the query database, the scoring module 234 may be configured to determine if the relationship satisfies a threshold that indicates a particular query is a next query that should be presented to the user. The relationship may be evaluated based on a set of relatedness criteria in order to determine whether the relationship satisfies the threshold. In some embodiments, this can help to ensure that queries posed to the user are only those that are sufficiently similar to the content of the driving conditions and from the query database. This may help to ensure that the queries selected and sent to the user are appropriate to the driving conditions and sufficiently similar to queries in the database, in order to present the user with a unified, thorough survey.

In some embodiments, after a relationship identified by the relationship identifier 232 satisfies the standards of the scoring module 234, the searching module 228 may search one or more databases to determine whether or not the generated query needs to be sent to the user. For example, the searching module 28 can search one or more ingested or external databases that may comprise a particular set of queries aimed to a particular user group. For example, an automotive manufacturer may submit a set of queries that the automotive manufacturer wishes to use to collect data from a particular set of users.

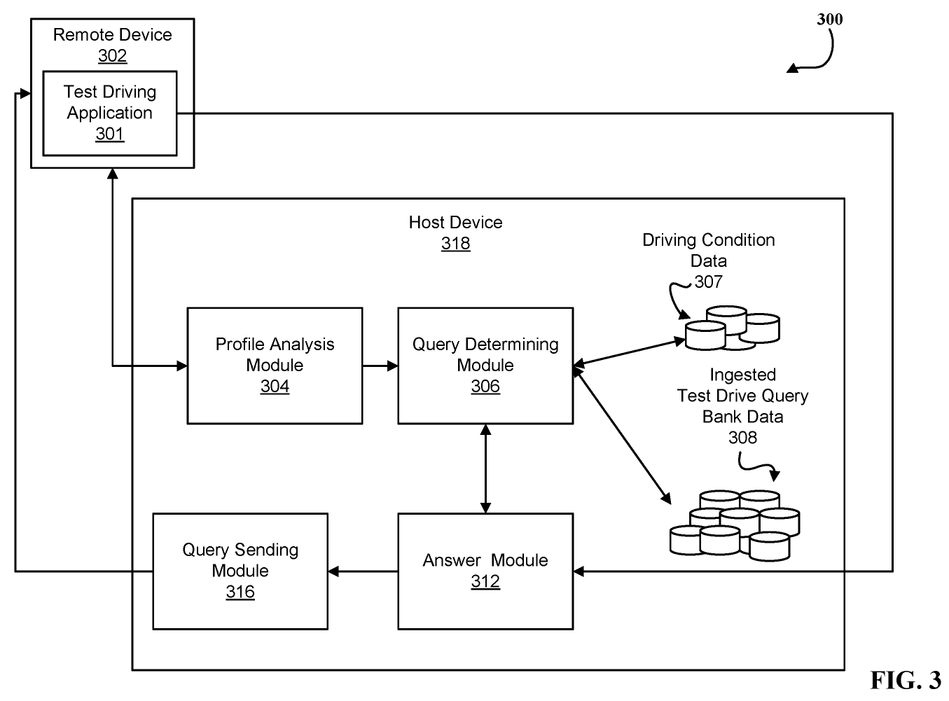

FIG. 3 depicts a system diagram of an example of a high level logical architecture of a Question Answering (QA) system 300 configured to use a profile, answer, and driving conditions to generate queries for a test drive survey, according to embodiments. In embodiments, host device 318 and remote device 302 of the QA system 300 may be embodied by host device 122 and remote device 112 of FIG. 1, respectively. In some embodiments, the profile analysis module 304, located on host device 318, may receive a natural language answer from a remote device 302, and can analyze the answer, and profile data, to produce an ingested form of the answer based on its content and context type. In embodiments, the answer can be sent by the remote device 302 from a test driving application 301. The answer can be a first answer, or it can be one that was received in response to an initially posed question. For example, if the answer is a first answer, it may be log in credentials or other data that indicates a user profile is available. In other embodiments, the answer may be one received from a device in response to a previously posed query (e.g., a query sent by sending module 316). An analysis produced by profile analysis module 304 may include, for example, the semantic type of the expected query type.

In some embodiments, the query determining module 306 may formulate queries from the output of the profile analysis module 304 and may consult various resources e.g., databases or corpora, to retrieve content that is relevant to generating a query based on the ingested profile and any previous answers received. In embodiments, the databases or corpora includes only a single ingested work of authorship 308. In embodiments, the driving condition data 307 may be data received from an external device, for example remote device 112 from FIG. 1. The driving condition data 307 may be received in real-time, or it may be collected at predetermined intervals and stored in one or more databases. In embodiments, query determining module 306 may consult ingested test drive query bank data 308. In embodiments, the ingested test drive query bank 308 may include one or more corpora of queries received from a survey generating company. For example, the ingested test drive query bank data 308 can include a generalized query database, or can include a set of queries tailored to a particular user profile or set of user profiles.

As shown in FIG. 3, the query determining module 306 may consult ingested driving condition data 307 and ingested test drive query bank data 308. The answer module 312 may then compare, with an answer received from the test driving application 301 on the remote device 302, the set of one or more queries selected by the query determining module 306. At this point, the system can determine a most logical next question, based on the answer (if any) received from the remote device. As described herein, NLP may be used to make this determination. The answer module can assess the queries and select, by assigning a score to each candidate query, a query to be sent to the user via the remote device 302. The selected query can then be passed to the query sending module 316, which can then send, to the remote device 302, the query. In some embodiments, the query sending module 316 can also send the query to a database, for example a database maintained by a company or group administering the survey.

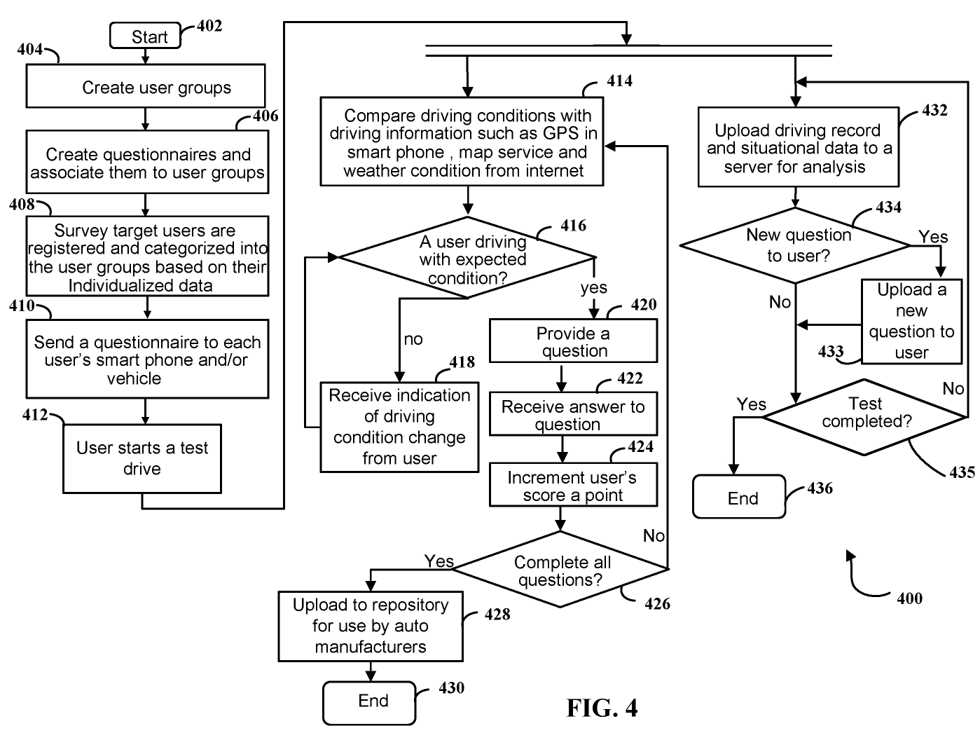

FIG. 4 depicts a flow diagram of a method 400 for developing and sending a driving survey to a user, based on driving conditions and driving situations, according to embodiments. The method 400 may start at 402, and a system can create one or more user groups, per 404. In embodiments, these user groups can include a set of one or more profiles, where the profiles may be grouped according to one or more characteristics, as determined by, for example, an automotive manufacturer. These characteristics could include, for example, geographic location, age, driving experience, type of vehicle in which the user is interested, or other data. In some embodiments, a user group can be synonymous with a user profile, allowing for individualized survey creation based on characteristics described above.

In embodiments, a questionnaire or survey can be created and associated with a user group, per 406. In some embodiments, this questionnaire can include an initial set of questions that may be delivered to a user prior to a test drive. In other embodiments, the creation of the questionnaire can include a selection of a subset of queries from a database of queries (for example a subset of ingested test drive query data bank 308 of FIG. 3). In embodiments, the subset selection can be based on the user group or user profile. The group of users who may be taking the survey (e.g., those registered to test drive a particular vehicle or vehicles on a particular date or time) can then be registered and sorted into user groups based on their data, per 408. In embodiments, this may involve further grouping the users based on each user's profile data. In embodiments, this step may occur during the initial creation of groups at 404. The system may then send a questionnaire to a user's smart phone or vehicle, per 410. In embodiments, the smartphone or vehicle may be e.g., remote device 302 of FIG. 3. The user may then begin the test drive, per 412.

Once the test drive has begun, the system may follow paths 414 to 430 at the same time following 432 to 436. The system may compare driving conditions with driving information including GPS data from a smartphone, map service data, or weather condition data from the internet, per 414. The system can then validate the driving condition by determining whether or not the user is driving with the expected condition, per 416. If the driver is not experiencing the expected condition, per 416, the system can receive an indication of the driving condition change from the user, per 418. In some embodiments, the system may ‘correct’ the user, by instructing the user to move to a particular driving condition. For example, if a query regarding vehicle handling at a slower speed is necessary to complete the survey, the system may direct the user to drive more quickly, in order to ensure that the user is responding to the query under accurate, expected conditions. Other examples may include the system instructing the user to “please drive in rain”, “please drive on a hill”, please drive on a highway”, or others.

If at 416, the system determines that the user is driving with the expected condition, the system can provide the user with a question, per 420. In embodiments, this question may be selected using NLP, as described herein. In embodiments, this question may be one selected from the initially determined questionnaire, which may be a subset of a larger questionnaire database provided by, for example, the survey administrator. The system can then receive an answer to the question, per 422. In some embodiments, the system can then increment a user's score a point, per 424. For example, a point system could be tied to the user's completion of the survey. As described herein, the point system may be a part of a larger incentive system, which can reward a user for responding promptly to system-initiated questions, and for satisfying certain driving criteria. The system can then determine whether or not the user has completed all questions necessary for the survey, per 426. If not, the system can then return to 414 and compare the driving conditions with available driving data.

If the system determines that the user has completed all questions at 426, the system can then upload questions, responses, and available condition data to a repository for user by the administering automotive manufacturer. In embodiments, this data may then be stored and further analyzed in aggregate, or used in another manner.

Upon the user starting the test drive, per 412, the system can also upload a driving record and situational data to a server for analysis, per 432. The system can then determine whether or not a new question is available and needs to be sent to the user, per 434. If yes, the system may upload a new question to the user, per 433. If not, the system can detect a completed test, per 435. If the test is not yet completed, the system may upload the updated driving record and situational data for use by the system in query generation, per 432. If the test is complete, at 435, the system may end, per 436.

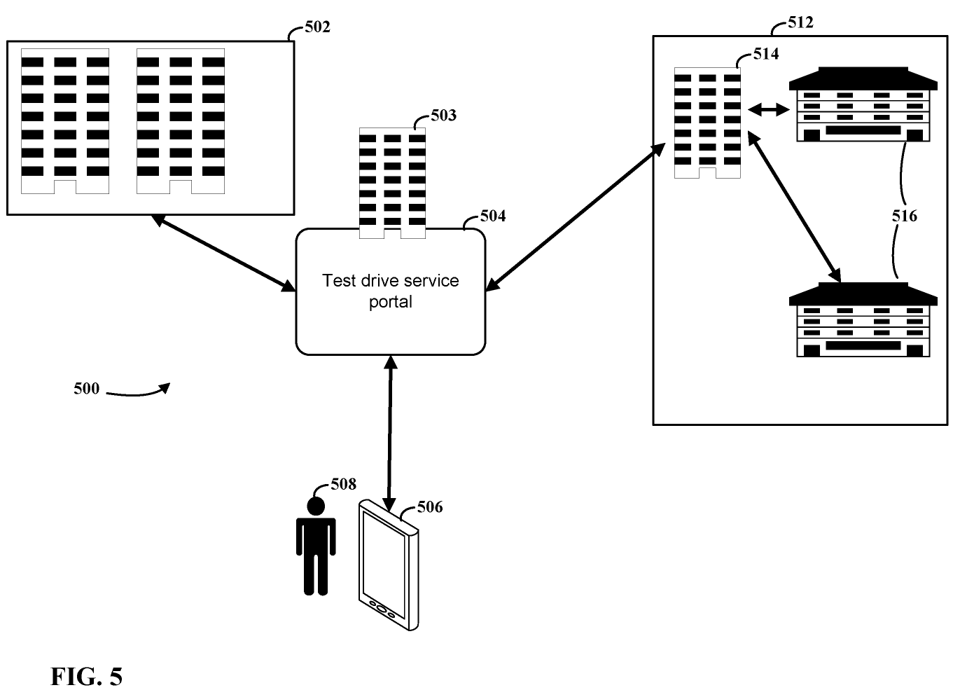

FIG. 5 depicts a system diagram of an incentives offer solution for a user test driving a vehicle, according to embodiments. The incentive solution may comprise a group of one or more automotive manufacturers 502. The system may also include a test drive survey administering company 503. In embodiments, the test drive administering company 503 may be one or more of the automotive manufacturers 502. In some cases, the automotive manufacturing company may outsource the service, and in others it may be a part of the company's internal operations. The test drive survey administering company 503 may manage a test drive service portal 504. The service portal 504 may be a host device, e.g., host device 122 of FIG. 1.

In embodiments, the test drive service portal 504 may communicate with the automotive manufactures 502. The portal 504 may also communicate with one or more client devices 506 over a network, (e.g., remote device 102 and network 150 of FIG. 1). As pictured, one or more users 508 may receive and send data, (e.g., one or more queries and answers that are part of a test drive survey), from the test drive service portal 504. For example, the user may register individualized data, using an application on the client device 506, in order to provide a profile to the test drive service portal 504. The user 508 may also receive incentives including, for example, coupons or other discounts for local businesses, based on completion of various parts of the survey. These incentives (e.g., coupons) may be communicated from the test drive service portal 504 to the client device 506.

In embodiments, the test drive service portal 504 may also communicate with one or more incentive offer solutions 512. An incentive offer solution 512 may include one or more coupon service companies 514, and one or more shops 516, including restaurants, clothing stores, coffee shops, and other retailers. In embodiments, the test drive service portal 504 may receive data, including e.g., registration data and coupon data, from one or more coupon service companies 514. The coupon service company 514 can receive, from one or more shops 516, various coupons or deals that can be offered to a test driver, in response to completing the survey.

This system may allow for a user 508 (e.g., a test driver of a vehicle) to be rewarded for completing a survey, following various directions required to respond to a particular query, and responding promptly and accurately to the system.

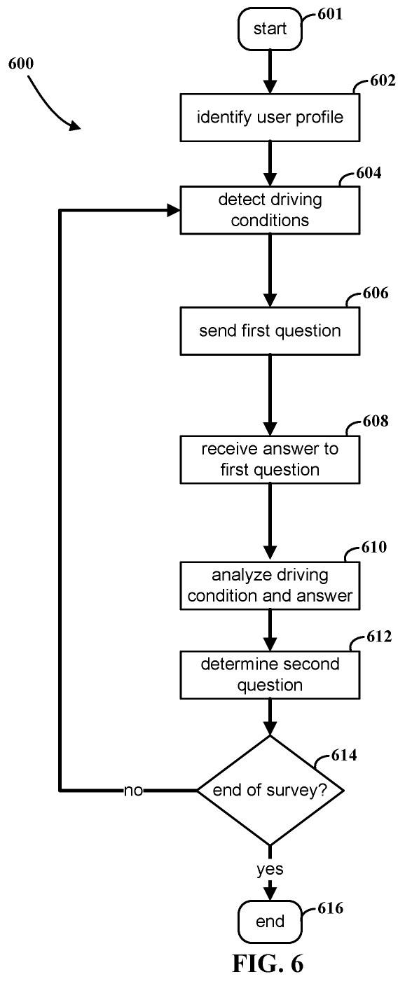

FIG. 6 depicts a flow diagram of a method 600 for generating a question for a test drive, according to embodiments. In embodiments, the method 600 may start at 601 and a user profile is identified, per 602. For example, data for a user profile could have been entered by a user into a remote device (e.g., a smartphone), and sent to a survey generating system. The system can then detect driving conditions, per 604. In some embodiments, the system may detect the driving conditions based on sensor data received from one or more sensors on the particular vehicle identified for the test drive. Based on the profile and the driving conditions, the system may send a first question, per 606.

In some embodiments, the system may have one or more answers to previous questions that may be factored into the initial question. In another embodiment, the system may have sorted, based on data in the user profile, the user into a particular category, where the particular category is associated with a subset of questions. In this embodiment, the system could also factor in the particular category when determining the first question, at 606. The system can then monitor for and receive an answer to the first question, per 608. For example, the answer may be received from a user who speaks into a client device (e.g., smartphone), which is connected to the vehicle (e.g., via BLUETOOTH or wirelessly). The system may then analyze the driving condition and the answer, per 610. In some embodiments, the analysis may include NLP processing. The analysis may also occur on a server or a device external to the system, and the data may be uploaded to the server for analysis and downloaded from the server. Based on the analysis, the system may then determine a second question, per 612. The system may then determine whether or not the survey is complete, at 614. If the survey is determined not to be complete, at 614, the system may then return to monitoring for and detecting driving conditions, per 604. If the system, at 614, determines the survey is complete, the method may end, per 616.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for administering a survey to a user test driving a vehicle, the method comprising:
identifying a user profile, the user profile associated with the user;
detecting, from one or more external devices, a driving condition;
sending, to a client device and based on the driving condition, a first query of the survey;
receiving, from the client device, an answer to the first query;
analyzing the driving condition and the answer to the first query; and
determining, based on the analyzing, a second query of the survey to send to the client device.

2. The method of claim 1 further comprising:
assigning, prior to the detecting and based on data in the user profile, the user profile to a particular user group; and
accessing, from a server, a set of potential queries, the set of potential queries associated with the user group, wherein the first query of the survey and the second query of the survey are selected from the set of potential queries associated with the user group.

3. The method of claim 1, further comprising:
determining, prior to the sending and using natural language processing (NLP), the first query of the survey.

4. The method of claim 3, wherein the determining is based off the driving condition, a set of one or more received answers, the user profile, and a subset of queries provided by a survey administrator, wherein the subset of queries is accessed from a database on a server.

5. The method of claim 1, further comprising sending, in response to the receiving the answer to the first query, an incentive to the client device.

6. The method of claim 5 wherein the incentive includes a coupon.

7. The method of claim 1, wherein the external devices include a set of one or more sensors, the sensors located in and on the vehicle.

8. The method of claim 1, wherein the analyzing comprises using NLP.

9. The method of claim 1, further comprising uploading, to a server, the driving condition and the answer to the first query, and wherein the analyzing occurs on the server.

10. A system for administering a survey to a user test driving a vehicle, the system comprising:
a computer readable storage medium with program instructions stored thereon; and
one or more processors configured to execute the program instructions to perform a method comprising:
identifying a user profile, the user profile associated with the user;
detecting, from a set of one or more external devices, a driving condition;
sending, to a client device and based on the driving condition, a first query of the survey;
receiving, from the client device, an answer to the first query;
analyzing the driving condition and the answer to the first query; and
determining, based on the analyzing, a second query of the survey to send to the client device.

11. The system of claim 10, wherein the method further comprises:
assigning, prior to the detecting and based on data in the user profile, the user profile to a particular user group; and
accessing, from a server, a set of potential queries, the set of potential queries associated with the user group, wherein the first query of the survey and the second query of the survey are selected from the set of potential queries associated with the user group.

12. The system of claim 10, wherein the method further comprises determining, prior to the sending and using natural language processing (NLP), the first query of the survey.

13. The system of claim 12, wherein the determining is based off the driving condition, a set of one or more received answers, the user profile, and a subset of queries provided by a survey administrator, wherein the subset of queries is accessed from a database on a server.

14. The system of claim 10, wherein the method further comprises sending, in response to the receiving the answer to the first query, an incentive to the client device.

15. The system of claim 14, wherein the incentive includes a coupon.

16. The system of claim 10, further comprising the set of one or more external devices, wherein the set of one or more external devices includes a set of one or more sensors, the sensors located in and on the vehicle.

17. The system of claim 10, wherein the analyzing comprises using NLP.

18. The system of claim 10, wherein the method further comprises uploading, to a server, the driving condition and the answer to the first query, and wherein the analyzing occurs on the server.

19. A computer program product for administering a survey to a user test driving a vehicle, the computer program product comprising a compute readable storage medium having program instructions embodied therewith, wherein the computer readable storage medium is not a transitory signal per se, the program instructions executable by a computer processor to cause the processor to perform a method comprising:
identifying a user profile, the user profile associated with the user;
detecting, from a set of one or more external devices, a driving condition;
sending, to a client device and based on the driving condition, a first query of the survey;
receiving, from the client device, an answer to the first query;
analyzing the driving condition and the answer to the first query; and
determining, based on the analyzing, a second query of the survey to send to the client device.

20. The computer program product of claim 19, wherein the method further comprises:
assigning, prior to the detecting and based on data in the user profile, the user profile to a particular user group; and
accessing, from a server, a set of potential queries, the set of potential queries associated with the user group, wherein the first query of the survey and the second query of the survey are selected from the set of potential queries associated with the user group.
